(19) United States
(12) Patent Application Publication
(10) Pub. No.: US 2019/0143253 A1
(43) Pub. Date: May 16, 2019

(54) Mask and Method for Manufacturing Same

(71) Applicant: 3M INNOVATIVE PROPERTIES COMPANY, St. Paul, MN (US)

(72) Inventors: Jin-Ho Lee, Seoul (KR); Kangsoo Park, Osan-si (KR)

(21) Appl. No.: 16/186,898

(22) Filed: Nov. 12, 2018

(30) Foreign Application Priority Data
Nov. 13, 2017 (KR) 10-2017-0150828

(51) Int. Cl. B01D 39/16; A62B 23/02; A62B 7/10; A62B 18/02; A62B 18/08

(52) U.S. Cl. CPC B01D 39/1623; B01D 39/1669; A62B 23/025; A62B 7/10; A62B 18/025; A62B 18/10; B01D 2239/0618; B01D 2239/0654; B01D 2239/0672; B01D 2239/10; B01D 2239/1291; A62B 18/08

(57) ABSTRACT

A mask according to an embodiment of the present disclosure includes a filter structure provided in a form in which a plurality of members are laminated, and a fiber sheet coupled to a circumferential part of the filter structure and configured to come into contact with a user's face, wherein the fiber sheet may be manufactured using an isotropic fiber sheet.

### TECHNICAL FIELD

The present disclosure relates to a mask and method of manufacturing the same.

### BACKGROUND

Masks, which are used to prevent introduction of impurities or contaminants into respiratory pathways of users, may be classified into masks including a separate filter part and filter face masks in which a mask main body itself functions as a filter.

In this case, generally, the filter face masks may be classified into masks having two different structures, that is, a fold-flat mask and a shaped mask. The fold-flat mask has a structure in which the mask is stored in a flat state but is unfolded in a cup shape upon use, and the shaped mask has a structure in which the mask has a face-fitting configuration such that the mask is manufactured in a predetermined shape, e.g., a cup shape, and maintains such a shape during storage and use.

A separate sheet member may be coupled to a portion of the mask coming into contact with the face of a wearer of the mask so as to improve wearability of the wearer. The sheet member may not only come into contact with the wearer's face and improve the wearability but also may decrease a gap generated between the mask and the wearer's face and play the role of preventing the introduction of foreign substances from the outside to an inner side of the mask without filtering.

Accordingly, in recent years, research on ways to further strengthen such a role of the sheet member has been carried out.

### SUMMARY

It is an object of the present disclosure to provide a mask with improved wearability and whose deformation is minimized during manufacture and a method of manufacturing the same.

A mask according to an embodiment of the present disclosure includes a filter structure provided in a form in which a plurality of members are laminated, and a fiber sheet coupled to a circumferential part of the filter structure and configured to come into contact with a user's face, wherein the fiber sheet satisfies at least one of Conditional Expressions 1 to 3 below.

0.86≤CD1/MD1≤1.23 [Conditional Expression 1

(⋅.⋅ CD1 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction, and

MD1 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction)

0.79≤CD2/MD2≤2.2 Conditional Expression 2

(⋅.⋅ CD2 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and

MD2 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction and then removed)

0.98≤CD3/MD3≤1.1 Conditional Expression 3

(⋅.⋅ CD3 represents a recovery rate of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and

MD3 represents a recovery rate of a fiber sheet sample when the fiber sheet sample is manufactured such that a long side of a rectangle, whose long side is 4 in inches length and short side is 1 inch in length, is disposed in a transverse direction of the fiber sheet and a force of 0.51 bf is applied to the fiber sheet sample in a long side direction and then removed).

The wearability of a mask according to an embodiment of the present disclosure can be improved.

Further, a method of manufacturing a mask according to an embodiment of the present disclosure can minimize deformation of the mask during manufacture of the mask.

### BRIEF DESCRIPTION OF THE DRAWINGS

FIG. 1 is a perspective view of a mask according to an embodiment of the present disclosure.

FIG. 2 is an exploded perspective view of the mask according to the embodiment of the present disclosure.

FIG. 3 is a cross-sectional view taken along line A-A′ in FIG. 1.

FIG. 4 is an exploded perspective view of a mask according to another embodiment of the present disclosure.

FIG. 5 is a cross-sectional view of the mask according to the other embodiment of the present disclosure.

FIG. 6 is a flowchart schematically illustrating a process of manufacturing a mask according to an embodiment of the present disclosure.

FIG. 7 is a reference view illustrating a process of manufacturing a sample of a fiber sheet included in the mask according to the embodiment of the present disclosure.

FIG. 8 is a reference view illustrating a fabric structure of the fiber sheet included in the mask according to the embodiment of the present disclosure.

FIGS. 9A and 9B are perspective views of a single piece of fabric constituting the fiber sheet included in the mask according to the embodiment of the present disclosure.

### DETAILED DESCRIPTION

Hereinafter, specific embodiments for implementing the idea of the present disclosure will be described in detail with reference to the accompanying drawings. In this case, note that the drawings are not drawn to scale for convenience of description. In addition, in describing the present disclosure, when detailed description of a related known configuration or function is deemed as having the possibility of blurring the gist of the present disclosure, the detailed description thereof will be omitted.

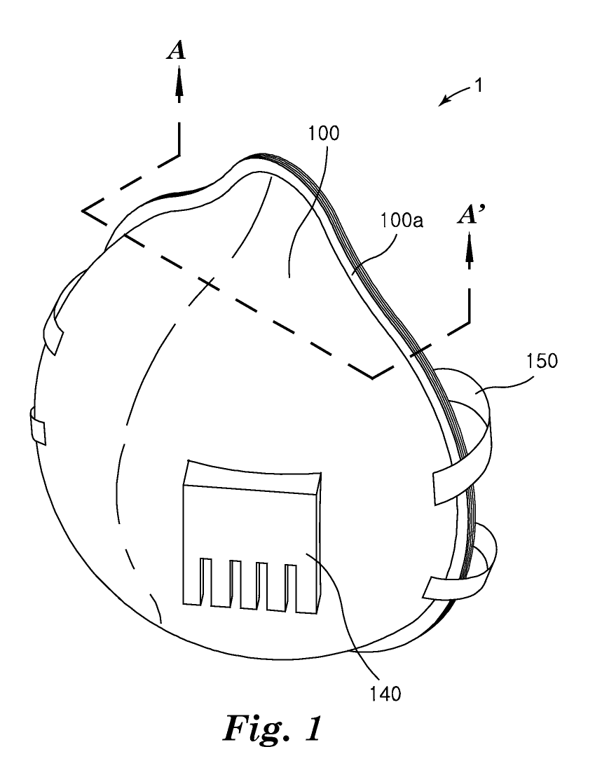

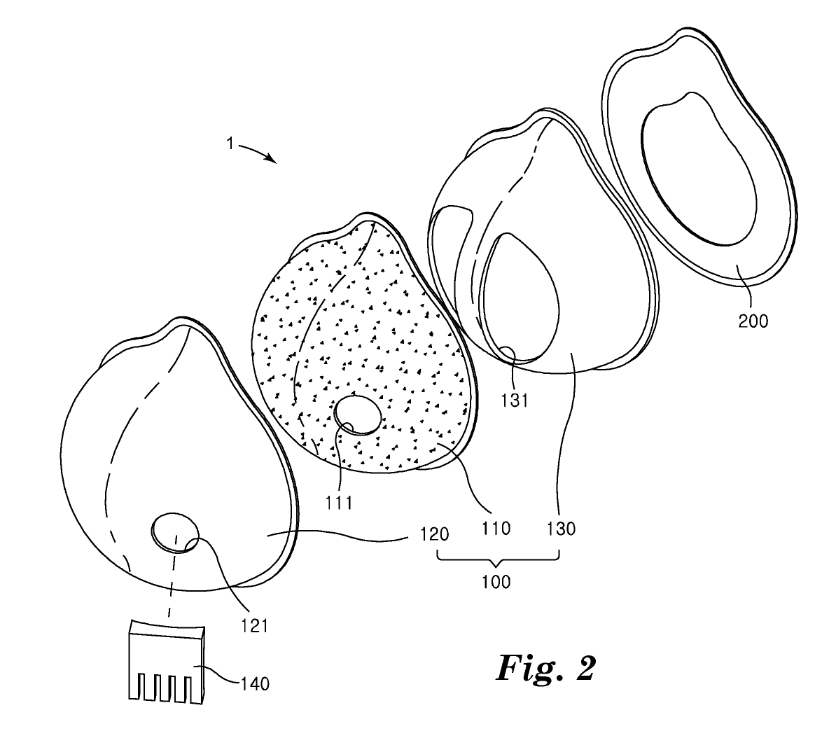

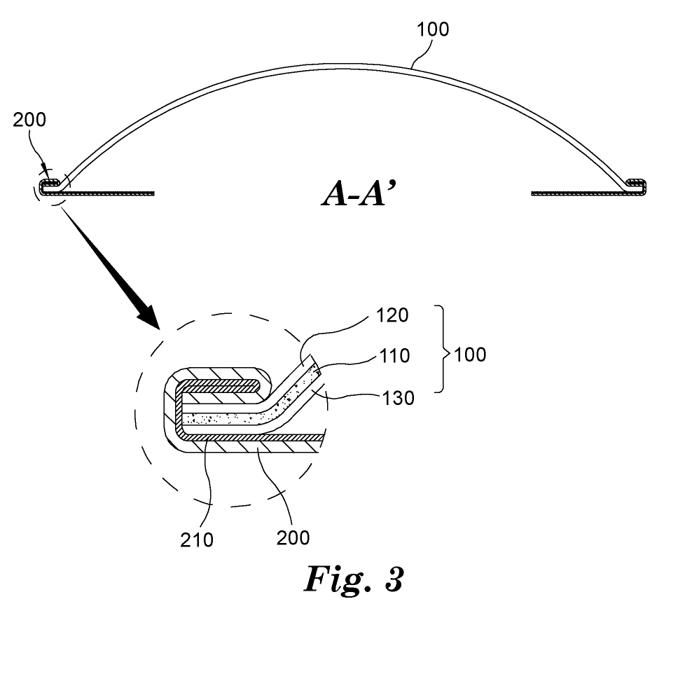

FIG. 1 is a perspective view of a mask according to an embodiment of the present disclosure, FIG. 2 is an exploded perspective view of the mask according to the embodiment of the present disclosure, and FIG. 3 is a cross-sectional view taken along line A-A′ in FIG. 1.

Referring to FIGS. 1 to 3, a mask 1 according to the embodiment of the present disclosure may be provided as a mask that is manufactured in a predetermined shape and is capable of maintaining the corresponding shape during storage and use. For example, the mask 1 may have an outer surface formed in an arch shape and may be manufactured to have a cup shape as a whole.

The mask 1 may include a filter structure 100 and a fiber sheet 200. The filter structure 100, which is provided to remove impurities from air passing through the filter structure 100 and filter the air, may form an outer surface of the mask 1, and a circumferential part 100a of the filter structure 100 may be coupled to the fiber sheet 200 which will be described below. Here, the circumferential part 100a of the filter structure 100 and the fiber sheet 200 may be coupled using various coupling methods. For example, the circumferential part 100a of the filter structure 100 and the fiber sheet 200 may be coupled using a heat welding or ultrasonic welding method. The coupling relationship between the filter structure 100 and the fiber sheet 200 will be described in detail below.

The filter structure 100 may be manufactured in a multilayer shape in which a plurality of members are laminated. For example, the filter structure 100 may include a filter layer 110 provided for filtering air, a cover web 120 coupled to an outer surface of the filter layer 110, and a support structure 130 coupled to an inner surface of the filter layer 110.

The filter layer 110 may be provided as a filter formed of a fiber material that is capable of achieving typically demanded filtering effects. In addition, the filter layer 110 may be provided in the form in which a plurality of filters formed of fiber materials that are coupled together by an adhesive or an arbitrary coupling means are laminated as necessary. A first opening 111 may be formed in the filter layer 110 for smooth air flow.

The cover wave 120 may be coupled to an outer surface of the filter layer 110. The cover wave 120 may be coupled to the outer surface of the filter layer 110 and may protect the filter layer 110 and prevent the filter layer 110 from being spaced apart from the support structure 130. The cover web 120 may be manufactured using a fiber material such as non-woven fabric. In addition, a second opening 121 may be formed in the cover web 120 for smooth air flow. Meanwhile, although a configuration in which the cover web 120 is only disposed at the outer surface of the filter layer 110 is illustrated in the drawings, the cover web 120 may also be disposed at both an inner surface and the outer surface of the filter layer 110, and the cover web 120 may also be omitted in some cases.

The support structure 130 may be coupled to the inner surface of the filter layer 110. The support structure 130 may be coupled to the inner surface of the filter layer 110 and maintain the overall shape of the mask 1. The support structure 130 may be manufactured using a porous member or a non-porous member. When the support structure 130 is manufactured using a porous member, the support structure may be manufactured using non-woven fabric. In addition, when the support structure 130 is manufactured using a non-porous member, the support structure 130 may be manufactured using a molded foam product that is formed by vacuum-forming or thermoforming foamed polyolefin. In addition, a third opening 131 may be formed in the support structure 130 for smooth air flow. In other words, when a user exhales, air may be discharged to the outside via a valve 140 by passing through the third opening 131, the first opening 111, and the second opening 121.

Circumferential part portions of the filter layer 110, the cover web 120, and the support structure 130 may be coupled to each other, for example, using a heat-welding or ultrasonic-welding method.

Meanwhile, the valve 140 may be provided at an outer surface of the filter structure 100. The valve 140, which is provided to facilitate breathing in a case in which the user breathes while wearing the mask 1, may be provided as a one-way valve that only allows air flow in one direction. For example, the valve 140 may be provided as a one-way valve that is closed when the user inhales and is opened when the user exhales.

A separate strap 150 may be coupled to the filter structure 100, and the user may wear the mask 1 by hanging the strap 150 on his or her ear.

The fiber sheet 200 may be coupled to the circumferential part 100a of the filter structure 100. The fiber sheet 200 may be coupled to the circumferential part 100a of the filter structure 100 using various methods, e.g., a heat-welding or ultrasonic-welding method.

The fiber sheet 200 may be provided as an isotropic fiber sheet in terms of elongation and elasticity. In terms of elongation, the isotropic fiber sheet may refer to a fiber sheet whose tensile elongation is constant when the same tensile force is applied regardless of a direction in which the fiber sheet is stretched, and in terms of elasticity, the isotropic fiber sheet may refer to a fiber sheet whose recovery rate is constant regardless of a direction of the fiber sheet when an external force is applied to the fiber sheet and then removed. Here, not only a fiber sheet whose tensile elongation and recovery rate have exactly the same values regardless of a direction, but also a fiber sheet that satisfies at least one of Conditional Expressions 1 to 3 below may be considered as corresponding to the isotropic fiber sheet in terms of elongation and elasticity.

0.86≤CD1/MD1≤1.23 Conditional Expression 1

(⋅.⋅ CD1 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction, and

MD1 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction)

0.79≤CD2/MD2≤2.2 Conditional Expression 2

(⋅.⋅ CD2 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and

MD2 represents tensile elongation of a fiber sheet sample when the fiber sheet sample is manufactured such that a long side of a rectangle, whose long side is 4 in in length and short side is 1 in in length, is disposed in a transverse direction of the fiber sheet and a force of 0.51 bf is applied to the fiber sheet sample in a long side direction and then removed)

0.98≤CD3/MD3≤1.1 Conditional Expression 3

(⋅.⋅ CD3 represents a recovery rate of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and

MD3 represents a recovery rate of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction and then removed)

Here, calculation methods of the above-listed conditional expressions will be briefly described with reference to FIG. 7. First, using a fiber sheet roll al, a fiber sheet sample t1 may be manufactured such that a long side is disposed in a longitudinal direction (x-axis direction based on FIG. 7) of the fiber sheet. Here, the fiber sheet sample t1 (hereinafter referred to as “Sample 1”) in which the long side is disposed in the longitudinal direction of the fiber sheet may be manufactured such that the long side is 4 inches in length and a short side is 1 inch in length. Then, using the fiber sheet roll al, a fiber sheet sample t2 may be manufactured such that a long side is disposed in a transverse direction (y-axis direction based on FIG. 7) of the fiber sheet. Here, the fiber sheet sample t2 (hereinafter referred to as “Sample 2”) in which the long side is disposed in the transverse direction of the fiber sheet may be manufactured such that the long side is 4 inches in length and a short side is 1 inch in length.

When the manufacture of Sample 1 and Sample 2 is completed, a length at which Sample 1 is stretched in comparison to its original length may be measured when the force of 0.51 bf is applied in the long side direction of Sample 1, and a value of CD1 in [Conditional Expression 1] may be obtained. Also, a length at which Sample 2 is stretched in comparison to its original length may be measured when the force of 0.51 bf is applied in the long side direction of Sample 2, and a value of MD1 in [Conditional Expression 1] may be obtained.

In addition, when the force of 0.51 bf is applied in the long side direction of Sample 1 and then removed, a length at which Sample 1 is stretched in comparison to its original length may be measured, and a value of CD2 in [Conditional Expression 2] and a value of CD3 in [Conditional Expression 3] may be obtained. In addition, when the force of 0.51 bf is applied in the long side direction of Sample 2 and then removed, a length at which Sample 2 is stretched in comparison to its original length may be measured, and a value of MD2 in [Conditional Expression 2] and a value of MD3 in [Conditional Expression 3] may be obtained. By going through such an experiment, the mask 1 according to the embodiment of the present disclosure may include a fiber sheet satisfying at least one of the above-listed Conditional Expressions 1 to 3.

The fiber sheet 200 may be manufactured using a material having elasticity, and when the user wears the mask 1, the fiber sheet 200 may improve wearability by being adhered to the user's face and reduce a gap between the filter structure 100 and the user's face, thereby preventing introduction of foreign substances from the outside to an inner portion of the mask 1 without passing through the filter structure 100.

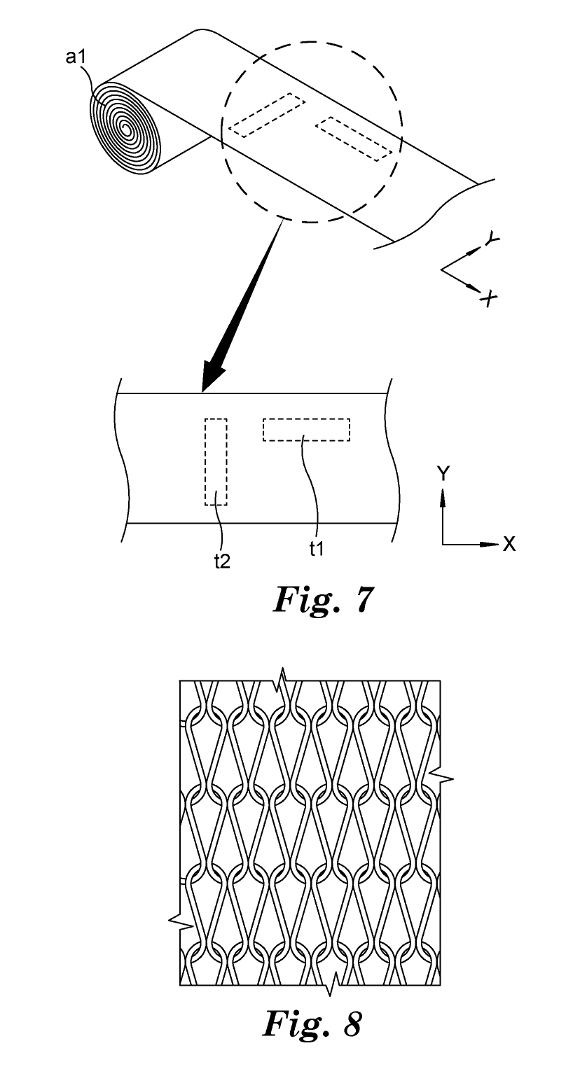

The fiber sheet 200 may be manufactured using a single jersey fabric structure that is woven using polyurethane fiber (see FIG. 8). For example, the fiber sheet may be manufactured using spandex.

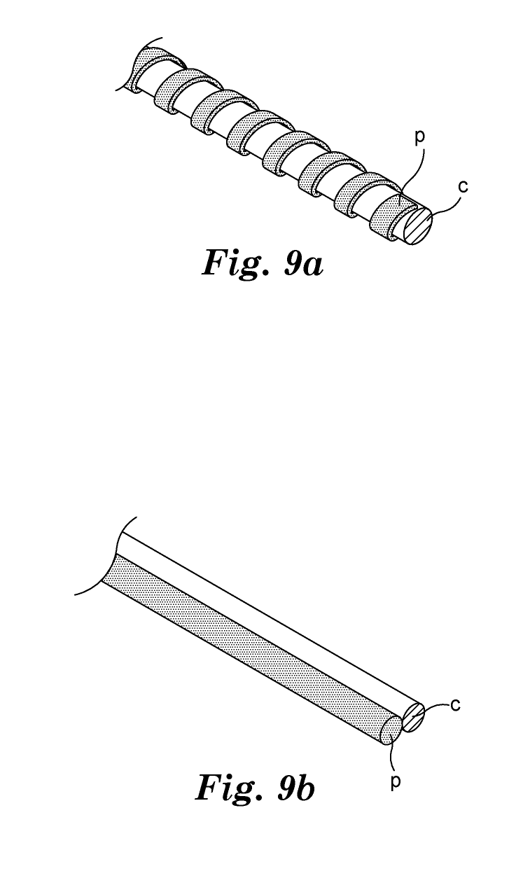

Further, the single fabric constituting the fiber sheet 200 may include core and polyester. For example, the fabric constituting the fiber sheet 200 may be provided by helically attaching polyester p to a core c formed of a spandex material (see FIG. 9A). Furthermore, fabric constituting the fiber sheet 200 may be provided by attaching or placing a strip of core c formed of spandex material and a strip of polyester p in the longitudinal direction (see FIG. 9B).

Meanwhile, a film 210 including polyester or polyurethane may be attached to one surface of the fiber sheet 200. The film 210 may be attached to one surface of the fiber sheet 200 and prevent introduction of air via the fiber sheet 200.

The fiber sheet 200 may be coupled to a front surface of an edge 100a of the filter structure 100. The fiber sheet 200 may be coupled to surround at least a portion of the edge 100a of the filter structure 100. Here, the other surface of the fiber sheet 200 to which the film 210 is not attached may come into contact with and be coupled to the front surface of the edge 100a of the filter structure 100 (see FIG. 3). Although it will be described below, in the case of a structure in which the fiber sheet 200 is coupled to the front surface of the edge 100a of the filter structure 100 as described above, a process in which the fiber sheet 200 is coupled to the edge 100a of the filter structure 100 and then flipped is performed. In the case of the mask 1 according to the embodiment of the present disclosure, due to the isotropy of the fiber sheet 200, mostly similar stress is acted throughout the edge 100a of the filter structure 100 during the process in which the fiber sheet 200 is flipped. Therefore, a phenomenon in which the filter structure 100 is deformed may be minimized.

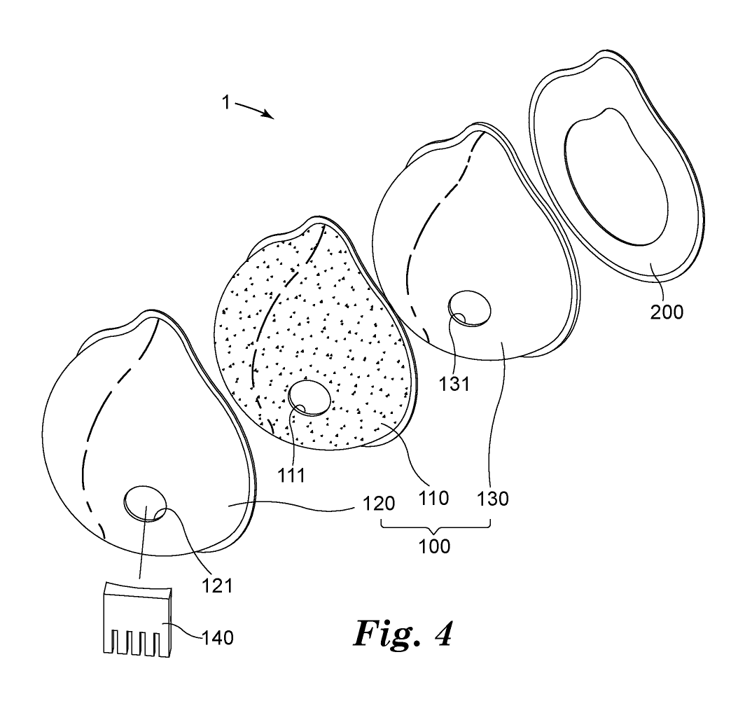

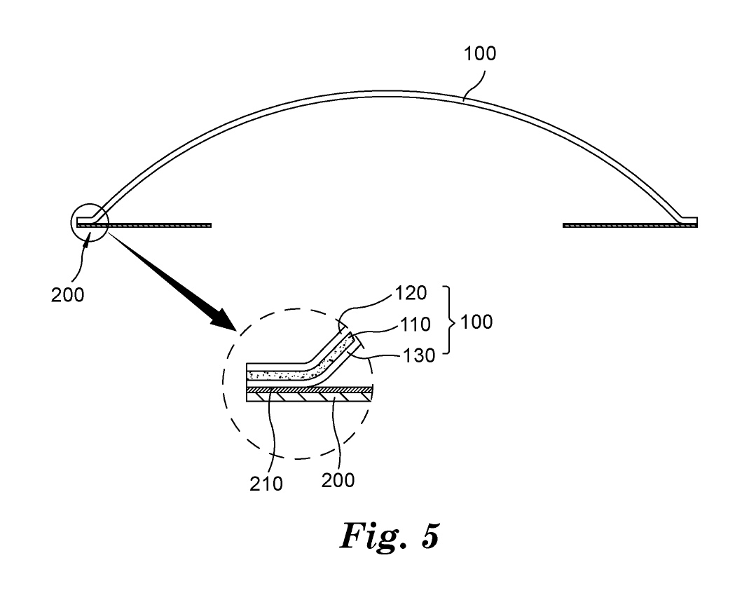

Meanwhile, the fiber sheet 200 may also be coupled to a rear surface of the circumferential part 100a of the filter structure 100. In other words, referring to FIGS. 4 and 5, the fiber sheet 200 may be coupled to the rear surface of the circumferential part 100a of the filter structure 100, and at this time, one surface of the fiber sheet 200, in other words, the surface of the fiber sheet 200 to which the film 210 is attached, may be coupled to the circumferential part 100a of the filter structure 100.

Hereinafter, a method of manufacturing a mask according to an embodiment of the present disclosure will be described. A method of manufacturing a mask 1 according to an embodiment of the present disclosure may include a first operation in which a filter structure 100 is manufactured by coupling a cover web 120 including non-woven fabric and a filter layer 110 configured to perform an air filtering function and a second operation in which a fiber sheet 200 is coupled to a front surface or a rear surface of a circumferential part 100a of the filter structure 100.

In the first operation, circumferential parts of the cover web 120 including non-woven fabric and the filter layer 110 configured to perform an air filtering function may be coupled to each other, for example, using a heat-welding or ultrasonic-welding method.

In the second operation, the fiber sheet 200 may be coupled to the front surface or the rear surface of the circumferential part 100a of the filter structure 100.

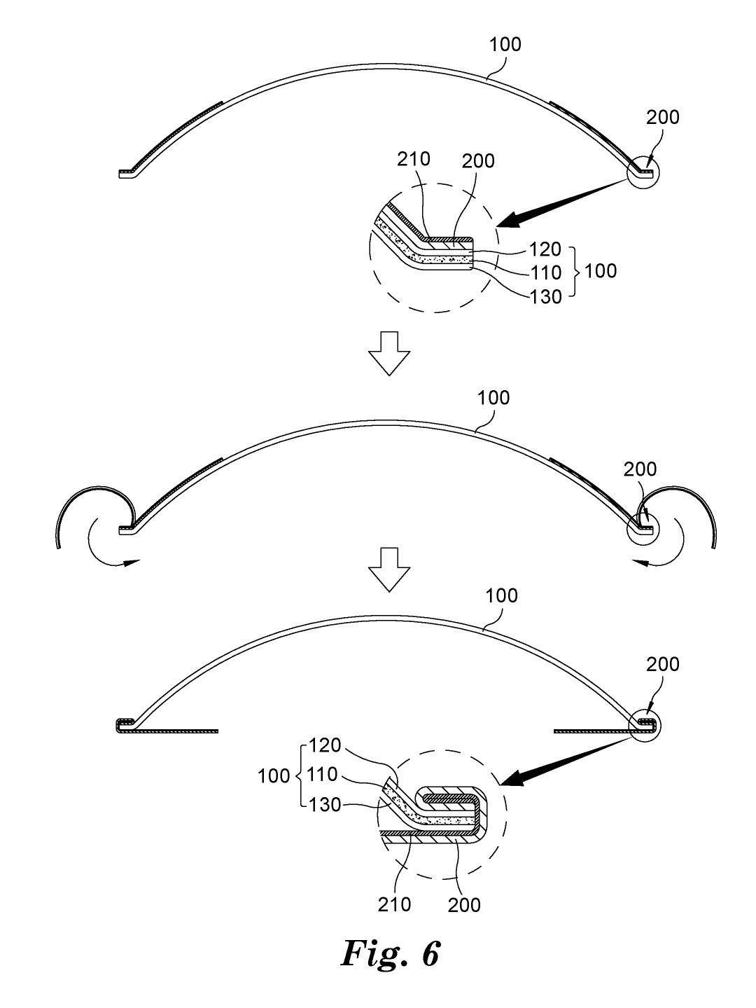

Here, referring to FIG. 6, when the fiber sheet 200 is coupled to the front surface of the circumferential part 100a of the filter structure 100, the fiber sheet 200 may be first disposed at the front surface side of the filter structure 100 and then flipped toward the rear of the filter structure 100. By this, an outer circumferential part of the fiber sheet 200 may surround at least a portion of the circumferential part 100a of the filter structure 100, and an inner circumferential part of the fiber sheet may be disposed behind the filter structure. Further, a film 210 including polyester or polyurethane may be attached to one surface of the fiber sheet 200, and the other surface of the fiber sheet 200 to which the film 210 is not attached may be coupled to the front surface of the circumferential part 100a of the filter structure 100.

On the other hand, when the fiber sheet 200 is coupled to the rear surface of the circumferential part 100a of the filter structure 100, the fiber sheet 200 may be coupled in a state in which the surface of the fiber sheet 200 to which the film 210 is attached is in contact with the rear surface of the circumferential part 100a of the filter structure 100. At this time, the fiber sheet 200 may be coupled to the rear surface of the circumferential part 100a of the filter structure 100 using a heat-welding or ultrasonic-welding method.

The following are lists of embodiments of the present disclosure.

Article 1 is a mask including a filter structure provided in a form in which a plurality of members are laminated, and a fiber sheet coupled to a circumferential part of the filter structure and configured to come into contact with a user's face, wherein the fiber sheet satisfies at least one of Conditional Expressions 1 to 3 below.

0.86≤CD1/MD1≤1.23 Conditional Expression 1

(⋅.⋅ CD1 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction of the fiber sheet sample, and

MD1 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction of the fiber sheet sample)

0.79≤CD2/MD2≤2.2 Conditional Expression 2

(⋅.⋅ CD2 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction of the fiber sheet sample and then removed, and

MD2 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction of the fiber sheet sample and then removed)

0.98≤CD3/MD3≤1.1 Conditional Expression 3

(⋅.⋅ CD3 represents a recovery rate of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction of the fiber sheet sample and then removed, and

MD3 represents a recovery rate of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction of the fiber sheet sample and then removed).

Article 2 is the mask in which the fiber sheet is formed of a single jersey fabric structure.

Article 3 is the mask in which the fiber sheet includes polyurethane fiber.

Article 4 is the mask in which a film including polyester or polyurethane is attached to one surface of the fiber sheet.

Article 5 is the mask in which the fiber sheet is coupled to surround at least a portion of the circumferential part of the filter structure, and the other surface of the fiber sheet is coupled to a front surface of the circumferential part of the fiber structure.

Article 6 is the mask in which one surface of the fiber sheet is coupled to a rear surface of the circumferential part of the filter structure.

Article 7 is the mask in which the filter structure includes a cover web forming an outer surface, a filter layer coupled to an inner surface of the cover web, and a support structure coupled to an inner surface of the filter layer.

Article 8 is the mask in which the support structure is formed of a molded foam product or non-woven fabric.

Article 9 is a method of manufacturing a mask including a first operation in which a filter structure is manufactured by coupling a cover web including non-woven fabric and a filter layer configured to perform an air filtering function and a second operation in which a fiber sheet is coupled to a front surface or a rear surface of a circumferential part of the filter structure, wherein the fiber sheet satisfies at least one of Conditional Expressions 1 to 3 below.

0.86≤CD1/MD1≤1.23 Conditional Expression 1

(⋅.⋅ CD1 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction of the fiber sheet sample, and

MD1 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction of the fiber sheet sample)

0.79≤CD2/MD2≤2.2 Conditional Expression 2

(⋅.⋅ CD2 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction of the fiber sheet sample and then removed, and

MD2 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction of the fiber sheet sample and then removed)

0.98≤CD3/MD3≤1.1 Conditional Expression 3

(⋅.⋅ CD3 represents a recovery rate of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction of the fiber sheet sample and then removed, and

MD3 represents a recovery rate of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction of the fiber sheet sample and then removed)

Article 10 is the method of manufacturing a mask in which, in the second operation, the fiber sheet is coupled to the front surface of the circumferential part of the filter structure, and the fiber sheet is flipped toward the rear of the filter structure such that an outer circumferential part of the fiber sheet surrounds at least a portion of the circumferential part of the filter structure, and an inner circumferential part of the fiber sheet is disposed behind the filter structure.

Article 11 is the method of manufacturing a mask in which a film including polyester or polyurethane is attached to one surface of the fiber sheet, and in the second operation, the other surface of the fiber sheet is coupled to the front surface of the circumferential part of the filter structure.

While the mask and method of manufacturing the same of the present disclosure have been described with reference to specific embodiments thereof, the embodiments are merely illustrative. The present disclosure is not limited thereto and should be interpreted as having the widest possible scope according to the fundamental idea disclosed herein. Those of ordinary skill in the art may combine/substitute the embodiments disclosed herein and practice the embodiments in patterns not described herein, and such patterns are also within the scope of the present disclosure. In addition, those of ordinary skill in the art may easily change or modify the embodiments disclosed herein on the basis of the present specification, and it is apparent that such changes or modifications also belong to the scope of the present disclosure.

What is claimed is:

1. A mask comprising:
a filter structure provided in a form in which a plurality of members are laminated; and
a fiber sheet coupled to a circumferential part of the filter structure and configured to come into contact with a user's face,
wherein the fiber sheet satisfies at least one of Conditional Expressions 1 to 3 below:
0.86≤CD1/MD1≤1.23 Conditional Expression 1
(⋅.⋅ CD1 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction, and
MD1 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction)
0.79≤CD2/MD2≤2.2 Conditional Expression 2
(⋅.⋅ CD2 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and
MD2 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction and then removed)
0.98≤CD3/MD3≤1.1 Conditional Expression 3
(⋅.⋅ CD3 represents a recovery rate of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and
MD3 represents a recovery rate of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction and then removed).

2. The mask of claim 1, wherein the fiber sheet is formed of a single jersey fabric structure.

3. The mask of claim 1, wherein the fiber sheet includes polyurethane fiber.

4. The mask of claim 1, wherein a film including polyester or polyurethane is attached to one surface of the fiber sheet.

5. The mask of claim 4, wherein:
the fiber sheet is coupled to surround at least a portion of the circumferential part of the filter structure; and
the other surface of the fiber sheet is coupled to a front surface of the circumferential part of the fiber structure.

6. The mask of claim 4, wherein one surface of the fiber sheet is coupled to a rear surface of the circumferential part of the filter structure.

7. The mask of claim 1, wherein the filter structure includes:
a cover web forming an outer surface;
a filter layer coupled to an inner surface of the cover web; and
a support structure coupled to an inner surface of the filter layer.

8. The mask of claim 7, wherein the support structure is formed of a molded foam product or non-woven fabric.

9. A method of manufacturing a mask, the method comprising:
a first operation in which a filter structure is manufactured by coupling a cover web including non-woven fabric and a filter layer configured to perform an air filtering function; and
a second operation in which a fiber sheet is coupled to a front surface or a rear surface of a circumferential part of the filter structure,
wherein the fiber sheet satisfies at least one of Conditional Expressions 1 to 3 below:
0.86≤CD1/MD1≤1.23 Conditional Expression 1
(⋅.⋅ CD1 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction, and
MD1 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction)
0.79≤CD2/MD2≤2.2 Conditional Expression 2
(⋅.⋅ CD2 represents tensile elongation of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and
MD2 represents tensile elongation of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction and then removed)
0.98≤CD3/MD3≤1.1 Conditional Expression 3
(⋅.⋅ CD3 represents a recovery rate of a fiber sheet sample when the fiber sheet sample is manufactured such that a long side of a rectangle, whose long side is 4 inches in length and short side is 1 inch in length, is disposed in a longitudinal direction of the fiber sheet and a force of 0.51 bf is applied to the fiber sheet sample in a long side direction and then removed, and
MD3 represents a recovery rate of a fiber sheet sample when the fiber sheet sample is manufactured such that a long side of a rectangle, whose long side is 4 inches in length and short side is 1 inch in length, is disposed in a transverse direction of the fiber sheet and a force of 0.51 bf is applied to the fiber sheet sample in a long side direction and then removed).

10. The method of claim 9, wherein, in the second operation:
the fiber sheet is coupled to the front surface of the circumferential part of the filter structure; and
the fiber sheet is flipped toward the rear of the filter structure such that an outer circumferential part of the fiber sheet surrounds at least a portion of the circumferential part of the filter structure, and an inner circumferential part of the fiber sheet is disposed behind the filter structure.

11. The method of claim 10, wherein:
a film including polyester or polyurethane is attached to one surface of the fiber sheet; and
in the second operation, the other surface of the fiber sheet is coupled to the front surface of the circumferential part of the filter structure.
